(19) United States
(12) Patent Application Publication
(10) Pub. No.: US 2014/0307190 A1
(43) Pub. Date: Oct. 16, 2014

(54) DRIVING METHOD FOR LIQUID CRYSTAL DEVICE, LIQUID CRYSTAL DEVICE, AND ELECTRONIC DEVICE

(71) Applicant: Seiko Epson Corporation, Tokyo (JP)

(72) Inventor: Naoki Tomikawa, Fujimi-machi (JP)

(73) Assignee: Seiko Epson Corporation, Tokyo (JP)

(21) Appl. No.: 14/249,829

(22) Filed: Apr. 10, 2014

(30) Foreign Application Priority Data
Apr. 12, 2013 (JP) 2013-083766

(51) Int. Cl. G02F 1/133

(52) U.S. Cl. CPC G02F 1/13306
USPC 349/33

(57) ABSTRACT

In a liquid crystal device, pixel electrodes and a common electrode that opposes the pixel electrodes on another side of a liquid crystal layer are formed in a display region serving as a first region, and dummy pixel electrodes serving as first electrodes are formed in a dummy pixel region serving as a second region. A driving method for the liquid crystal device applies a voltage that is lower than a threshold voltage at which the transmissibility of liquid crystals changes between the dummy pixel electrodes and the common electrode. Accordingly, the dummy pixel electrodes can function as an electricity parting portion and ionic impurities can be pulled from the display region to the dummy pixel electrodes.

### BACKGROUND

1. Technical Field

The present invention relates to driving methods for liquid crystal devices, liquid crystal devices, and electronic devices that include such liquid crystal devices.

2. Related Art

A liquid crystal device includes a liquid crystal panel in which a liquid crystal layer is interposed between two substrates. When light is incident on such a liquid crystal device, a liquid crystal material, an orientation layer, and so on that configure the liquid crystal panel react photochemically with the incident light, and ionic impurities are sometimes produced by the reaction. It is furthermore known that ionic impurities diffuse into the liquid crystal layer from sealants, sealing members, and so on during the production of such a liquid crystal panel. In particular, the luminous density of the incident light is higher in a liquid crystal device such as an optical modulation unit (a light valve) that is used in a projection-type display apparatus (a projector) than in a direct-view liquid crystal device, and it is thus necessary to suppress the influence that ionic impurities have on the display.

As one technique for suppressing the influence that ionic impurities have on the display, for example, Japanese Patent No. 4,972,344 discloses a liquid crystal display apparatus and a driving method that uses an electricity parting region formed surrounding a display region as an ion sweeping unit. Electricity parting pixel electrodes are provided in the electricity parting region, and an AC voltage that displays black is applied to the electricity parting pixel electrodes during a display active mode, whereas an AC voltage for sweeping off ions within the liquid crystals is applied for a predetermined amount of time during a display inactive mode. It is described as being preferable that the frequency of the AC voltage applied to the electricity parting pixel electrodes for ion sweeping during the display inactive mode is approximately 10 to 100 times higher than the frequency of the AC voltage used to drive the pixels in the display region during the display active mode.

Meanwhile, JP-A-2013-25066 discloses an electro-optical apparatus having an ion trapping portion formed in an outer edge region between a pixel region in which a plurality of pixels are arranged and a sealant. The ion trapping portion has a first electrode and a second electrode that have comb-tooth shapes when viewed from above and that are disposed so that respective branch electrodes intermesh with each other. Voltages are applied based on the polarity of the ionic impurities that are to be trapped in the ion trapping portion, so that, for example, applying a −5 V DC voltage to the first electrode and a 0 V DC voltage to the second electrode traps ionic impurities that are positively charged. Likewise, for example, applying a 5 V DC voltage to the first electrode and a 0 V DC voltage to the second electrode traps ionic impurities that are negatively charged.

However, according to the liquid crystal display apparatus and driving method thereof disclosed in Japanese Patent No. 4,972,344, the ionic impurities are swept into the electricity parting region during the display inactive mode but are not swept during the display active mode, and there is thus a problem that the ionic impurities cannot be swept into the electricity parting region effectively. In addition, there is a risk that when an AC voltage at a frequency higher than that applied to pixel electrodes is applied to the electricity parting pixel electrodes, ionic impurities having positive or negative polarities will be unable to follow the change in the AC voltage, and the ionic impurities cannot be efficiently swept to the electricity parting pixel electrodes as a result.

Meanwhile, in the electro-optical apparatus disclosed in JP-A-2013-25066, the ion trapping portion is formed in a first substrate and a peripheral parting portion is formed in a position overlapping the ion trapping portion in a second substrate that opposes the first substrate on another side of the liquid crystal layer. When the orientation of the liquid crystal molecules changes due to a voltage being applied in the ion trapping portion between the first electrode and the second electrode, there is a risk that, depending on the precision of the assembly positioning of the first substrate and the second substrate, leaking light caused by changes in the orientation of the liquid crystal molecules in the ion trapping portion will be visible.

### SUMMARY

Having been conceived in order to solve at least part of the aforementioned problems, the invention is to provide liquid crystal devices, electronic devices, and driving methods thereof that can be implemented as the following aspects or application examples.

A driving method for a liquid crystal device according to an aspect of the invention is a driving method for a liquid crystal device in which liquid crystals are interposed between a first substrate and a second substrate affixed together using a sealant and that operates in a normally-black mode in which the transmissibility of pixels is minimum when no voltage is applied to the pixels. In this aspect, the liquid crystal device includes a first region in which an image is displayed and a second region positioned between the first region and the sealant and provided following the first region when viewed from above, pixel electrodes are formed in the first region on the side of the first substrate that faces the liquid crystals and a common electrode is formed in the first region on the side of the first substrate or the second substrate that faces the liquid crystals, a first electrode is formed in the second region on the side of the first substrate that faces the liquid crystals and a second electrode is formed in the second region on the side of the first substrate or the second substrate that faces the liquid crystals, and a voltage that is lower than a threshold voltage at which the transmissibility of the liquid crystals changes is applied between the first electrode and the second electrode.

According to this aspect, it is possible to provide a driving method for a liquid crystal device capable of pulling ionic impurities present in the liquid crystals of the first region into the second region and trapping the ionic impurities in the second region by applying a voltage that is lower than the threshold voltage at which the transmissibility of the liquid crystals changes between the first electrode and the second electrode in order to cause the second region to function as an electricity parting portion and by producing an electrical field between the first electrode and the second electrode.

It is preferable that, in the driving method of the liquid crystal device in the above example, an AC potential that shifts between a higher potential and a lower potential than a potential of the second electrode be applied to the first electrode.

According to this aspect, ionic impurities having positive and negative polarities can be pulled to the first electrode.

It is preferable that, in the driving method of the liquid crystal device in the above example, the frequency of the AC potential be the same as the frequency of an image signal supplied to the pixel electrodes in the first region.

According to this aspect, it is not necessary to generate an AC potential at a different frequency than the frequency of the image signal, and thus the configuration of a driving circuit in the liquid crystal device can be simplified.

Further, it is preferable that, in the driving method of the liquid crystal device in the above example a DC potential that is lower than a potential of the second electrode be applied to the first electrode.

According to this aspect, ionic impurities having a positive-polarity (cations) can be pulled into and trapped in the second region.

Furthermore, it is preferable that, in the driving method of the liquid crystal device in the above example, the liquid crystal device further include a third electrode provided between the second region and the sealant, and that a DC potential that is higher than a potential of the first electrode and lower than a potential of the second electrode be applied to the third electrode.

According to this aspect, positive-polarity ionic impurities (cations) pulled into the second region can be moved to and trapped by the third electrode disposed on the outer side of the second region. In other words, the positive-polarity ionic impurities (cations) can be prevented from accumulating in the second region, and thus the positive-polarity ionic impurities (cations) can be more effectively pulled into the second region from the first region.

It is preferable that, in the driving method of the liquid crystal device in the above example, the voltage applied between the first electrode and the second electrode be set to the same voltage as the threshold voltage or a higher voltage than the threshold voltage after a display period has ended.

According to this aspect, after the display period has ended, ionic impurities can be pulled into and trapped in the second region more effectively regardless of a display state in the first region.

A liquid crystal device according to another aspect of the invention is a liquid crystal device in which liquid crystals are interposed between a first substrate and a second substrate affixed together using a sealant and that operates in a normally-black mode in which the transmissibility of pixels is minimum when no voltage is applied to the pixels, and that includes a first region in which an image is displayed and a second region positioned between the first region and the sealant and provided following the first region when viewed from above; pixel electrodes are formed in the first region on the side of the first substrate that faces the liquid crystals and a common electrode is formed in the first region on the side of the first substrate or the second substrate that faces the liquid crystals, a first electrode is formed in the second region on the side of the first substrate that faces the liquid crystals and a second electrode is formed in the second region on the side of the first substrate or the second substrate that faces the liquid crystals, and a voltage that is lower than a threshold voltage at which the transmissibility of the liquid crystals changes is applied between the first electrode and the second electrode during a display period.

According to this aspect, it is possible to provide a liquid crystal device capable of pulling ionic impurities present in the liquid crystals of the first region into the second region and trapping the ionic impurities in the second region by applying, during a display period, a voltage that is lower than the threshold voltage at which the transmissibility of the liquid crystals changes between the first electrode and the second electrode in order to cause the second region to function as an electricity parting portion and by producing an electrical field between the first electrode and the second electrode.

It is preferable that, in the liquid crystal device in the above example, the common electrode be formed in the second substrate across the first region and the second region and also function as the second electrode.

According to this aspect, it is not necessary to form the second electrode separately, and thus a smaller liquid crystal device can be provided.

It is preferable that, in the liquid crystal device in the above example, the second electrode be formed in the first substrate.

According to this aspect, the first electrode and the second electrode are formed in the first substrate in the second region, and thus the second region can function as an electricity parting portion having a horizontal electrical field; this makes it be possible to provide a liquid crystal device that has an electricity parting portion capable of trapping ionic impurities and that has superior view angle properties.

It is preferable that, in the liquid crystal device in the above example, a third electrode be provided between the second region and the sealant, and a negative-polarity potential higher than a potential of the first electrode be applied to the third electrode.

According to this aspect, positive-polarity ionic impurities (cations) pulled into the second region can be moved to and trapped by the third electrode disposed on the outer side of the second region. In other words, the positive-polarity ionic impurities (cations) can be prevented from accumulating in the second region, and thus the positive-polarity ionic impurities (cations) can be more effectively pulled into the second region from the first region.

Furthermore, it is preferable that the liquid crystal device according to the aforementioned aspects include an inorganic orientation layer that covers the pixel electrode, the first electrode, the second electrode, and the common electrode.

Because an inorganic orientation layer easily adsorbs ionic impurities, according to this aspect, a VA-type liquid crystal device, for example, in which display problems caused by ionic impurities are less apparent, can be provided.

An electronic device according to another aspect of the invention includes a liquid crystal device in which liquid crystals are interposed between a first substrate and a second substrate affixed together using a sealant and that operates in a normally-black mode in which the transmissibility of pixels is minimum when no voltage is applied to the pixels, and the liquid crystal device is driven using the driving method for a liquid crystal device according to the aforementioned aspects.

It is preferable that an electronic device according to another aspect of the invention include the liquid crystal device according to the aforementioned aspects.

According to these aspects, an electronic device in which the second region functions as an electricity parting portion and that ameliorates display problems caused by ionic impurities can be provided.

### BRIEF DESCRIPTION OF THE DRAWINGS

The invention will be described with reference to the accompanying drawings, wherein like numbers reference like elements.

FIG. 1A is a plan view illustrating the overall configuration of a liquid crystal device according to a first embodiment, and FIG. 1B is an overall cross-sectional view taken along a IB-IB line indicated in FIG. 1A.

FIG. 2 is an equivalent circuit diagram illustrating the electrical configuration of the liquid crystal device according to the first embodiment.

FIG. 3 is a cross-sectional view illustrating the overall structure of a pixel in the liquid crystal device according to the first embodiment.

FIG. 4 is a plan view illustrating an overview of a relationship between an angled deposition direction of an inorganic material and display problems caused by ionic impurities.

FIG. 5A is a plan view illustrating an overview of an arrangement of active display pixels and dummy pixels, and FIG. 5B is a wiring diagram illustrating an electricity parting portion.

FIG. 6 is a cross-sectional view, taken along a VI-VI line in FIG. 5A, illustrating an overview of the structure of a liquid crystal panel.

FIG. 7 is a graph illustrating a relationship between a transmissibility and a driving voltage of a pixel in the liquid crystal device according to the first embodiment.

FIG. 8 is a wiring diagram illustrating the configuration of an electricity parting portion in a liquid crystal device according to a second embodiment.

FIG. 9 is a cross-sectional view illustrating the overall structure of the liquid crystal device according to the second embodiment.

FIG. 10 is a plan view illustrating the overall configuration of a pixel in a liquid crystal device according to a third embodiment.

FIG. 11 is a cross-sectional view illustrating the overall structure of an electricity parting portion in the liquid crystal device according to the third embodiment.

FIG. 12 is a plan view illustrating the overall configuration of a pixel in a liquid crystal device according to a fourth embodiment.

FIG. 13 is a cross-sectional view illustrating the overall structure of an electricity parting portion in the liquid crystal device according to the fourth embodiment.

FIG. 14 is a schematic diagram illustrating the configuration of a projection-type display apparatus.

### DESCRIPTION OF EXEMPLARY EMBODIMENTS

Hereinafter, specific embodiments of the invention will be described based on the drawings. Note that the drawings used here illustrate the areas being described in an enlarged or reduced manner so that those areas can be recognized properly.

Note also that in the following embodiments, the phrase “on a substrate” can refer, for example, to a constituent element being disposed directly on top of the substrate, a constituent element being disposed on top of the substrate with another constituent element provided therebetween, or part of the constituent element being disposed directly on top of the substrate while another part is disposed on top of the substrate with another constituent element provided therebetween.

### First Embodiment

This embodiment describes an active matrix-type liquid crystal device that includes thin-film transistors (TFTs) as pixel switching elements as an example. This liquid crystal device can be used favorably as an optical modulating element (a liquid crystal light valve) in a projection-type display apparatus (a liquid crystal projector), for example, which will be described later.

### Liquid Crystal Device

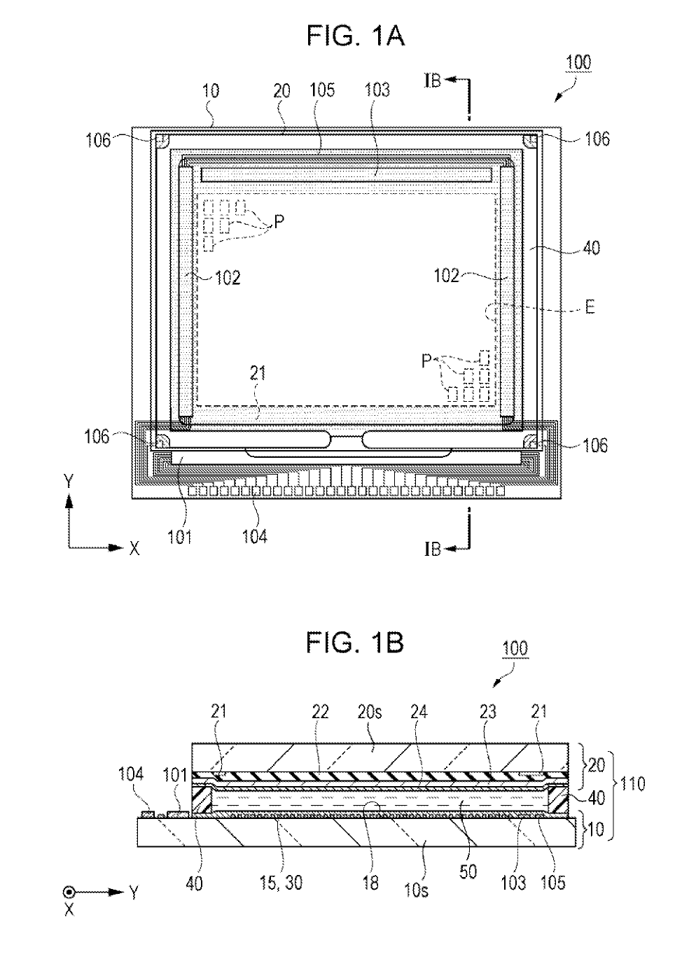

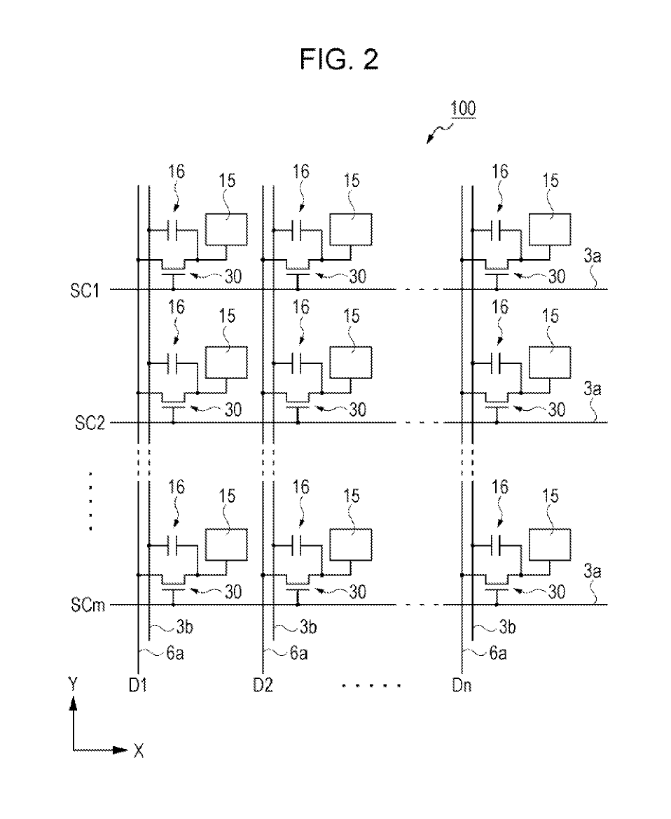

First, a liquid crystal device according to this embodiment will be described with reference to FIGS. 1A to 2. FIG. 1A is a general plan view illustrating the configuration of a liquid crystal device according to the first embodiment, and FIG. 1B is an overall cross-sectional view taken along a IB-IB line indicated in FIG. 1A. FIG. 2 is an equivalent circuit diagram illustrating the electrical configuration of the liquid crystal device according to the first embodiment.

As shown in FIGS. 1A and 1B, a liquid crystal device 100 according to this embodiment includes an element substrate 10 and an opposing substrate 20 that are disposed facing each other, and a liquid crystal layer 50 interposed between the stated two substrates. A substrate 10s of the element substrate 10 and a substrate 20s of the opposing substrate 20 both use a transparent substrate, such as a silica substrate, a glass substrate, or the like. The element substrate 10 corresponds to a first substrate according to the invention, and the opposing substrate 20 corresponds to a second substrate according to the invention.

The element substrate 10 is larger than the opposing substrate 20, and the substrates are affixed to each other using a sealant 40 disposed along an outer edge of the opposing substrate 20 so that a gap is present between the two substrates; the liquid crystal layer 50 is configured by filling the gap with liquid crystals having positive or negative dielectric anisotropy. An adhesive such as a thermosetting or ultraviolet light-curable epoxy resin is employed as the sealant 40. Spacers (not shown) for maintaining the aforementioned gap between the two substrates are intermixed with the sealant 40.

A pixel region E including a plurality of pixels P arranged in a matrix is provided on an inner side of the sealant 40. A parting portion 21 that surrounds the pixel region E is provided between the sealant 40 and the pixel region E. The parting portion 21 is configured of, for example, a metal or a metal oxidant that blocks light. Note that in addition to the plurality of pixels P that actively display, the pixel region E may also include dummy pixels disposed so as to surround the plurality of pixels P. Furthermore, although not shown in FIGS. 1A and 1B, a light-blocking portion that separates the plurality of pixels P from each other in the pixel region E when viewed from above (a “black matrix” or “BM”) is provided in the opposing substrate 20.

A terminal unit in which a plurality of external connection terminals 104 are arranged is provided in the element substrate 10. A data line driving circuit 101 is provided between a first side and the sealant 40 that follow the terminal unit. An examination circuit 103 is provided between the sealant 40 and the pixel region E, following a second side that opposes the first side. Furthermore, scanning line driving circuits 102 are provided between the sealant 40 and the pixel region E, following third and fourth sides, respectively, that oppose each other and are orthogonal to the first side. A plurality of wires 105 that connect the two scanning line driving circuits 102 are provided between the sealant 40 and the examination circuit 103 on the second side.

The wires that connect the data line driving circuit 101 and the scanning line driving circuits 102 are connected to the plurality of external connection terminals 104 arranged along the first side. The following descriptions will assume that a direction following the first side is an X direction, and a direction following the third side is a Y direction. Note that the location of the examination circuit 103 is not limited to that described above, and the examination circuit 103 may be provided along an inner side of the sealant 40, between the data line driving circuit 101 and the pixel region E.

As shown in FIG. 1B, a light-transmissive pixel electrode 15 and a thin-film transistor (“TFT”, hereinafter) 30 serving as a switching element are provided for each of the pixels P, along with signal lines, in the surface of the element substrate 10 facing the liquid crystal layer 50; an orientation layer 18 is formed so as to cover these elements. A light-blocking structure that prevents light from entering a semiconductor layer of the TFT 30 and destabilizing the switching operations of the TFT 30 is employed. The element substrate 10 includes the substrate 10s as well as the pixel electrodes 15, the TFTs 30, the signal lines, and the orientation layer 18 formed upon the substrate 10s.

The opposing substrate 20 disposed facing the element substrate 10 includes the substrate 20s, the parting portion 21 that is formed upon the substrate 20s, a planarizing layer 22 deposed so as to cover the parting portion 21, a common electrode 23 provided across at least the pixel region E and covering the planarizing layer 22, and an orientation layer 24 that covers the common electrode 23.

As shown in FIG. 1A, the parting portion 21 is provided so as to surround the pixel region E, in a location that overlaps with the scanning line driving circuits 102 and the examination circuit 103 when viewed from above. As a result, the parting portion 21 blocks light from being incident on the stated circuits from the opposing substrate 20 and prevents the stated circuits from operating erroneously due to such light. The parting portion 21 furthermore ensures high contrast in the display of the pixel region E by blocking unnecessary stray light from entering the pixel region E.

The planarizing layer 22 is configured of an inorganic material such as silicon oxide, is light-transmissive, and is provided so as to cover the parting portion 21. A method that employs plasma CVD can be given as an example of a method for forming the planarizing layer 22.

The common electrode 23 is configured of a transparent conductive film such as indium tin oxide (ITO), covers the planarizing layer 22, and is electrically connected to wires in the element substrate 10 by upper and lower conductive portions 106 provided at each of the four corners of the opposing substrate 20, as shown in FIG. 1A.

The orientation layer 18 that covers the pixel electrodes 15 and the orientation layer 24 that covers the common electrode 23 are selected based on the optical design of the liquid crystal device 100. Examples of such layers include an organic orientation layer produced by forming a film from an organic material such as a polyimide and rubbing the surface thereof to achieve an approximately horizontal orientation process on liquid crystal molecules having positive dielectric anisotropy, and an inorganic orientation layer produced by forming a film from an inorganic material such as silicon oxide (SiOx) through chemical vapor deposition and achieving approximately vertical orientation for liquid crystal molecules having negative dielectric anisotropy.

The liquid crystal device 100 is transmissive, and employs an optical design having a “normally-white mode”, in which the transmissibility of the pixels P is maximum when no voltage is being applied thereto, a “normally-black mode”, in which the transmissibility of the pixels P is minimum when no voltage is being applied thereto, or the like. Furthermore, depending on the optical design, polarizing elements are disposed on a light-entry side and a light-exit side of a liquid crystal panel 110 that includes the element substrate 10 and the opposing substrate 20.

Hereinafter, this embodiment will describe an example in which the aforementioned inorganic orientation layer is used for the orientation layers 18 and 24, liquid crystals having negative dielectric anisotropy are used, and a normally-black optical design is applied.

Next, the electrical configuration of the liquid crystal device 100 will be described with reference to FIG. 2. The liquid crystal device 100 includes, in at least the pixel region E, a plurality of scanning lines 3a and a plurality of data lines 6a, serving as signal lines that are insulated from each other and that are orthogonal to each other, as well as capacitance lines 3b disposed parallel to the data lines 6a. The scanning lines 3a extend in the X direction, whereas the data lines 6a extend in the Y direction.

The pixel electrodes 15, the TFTs 30, and storage capacitances 16 are provided at the scanning lines 3a, the data lines 6a, and the capacitance lines 3b and in each region defined by the signal lines, and configure the pixel circuits of the corresponding pixels P.

Each scanning line 3a is electrically connected to the gate of a corresponding TFT 30, and each data line 6a is electrically connected to the source of the corresponding TFT 30. Each pixel electrode 15 is electrically connected to the drain of the corresponding TFT 30.

The data lines 6a are connected to the data line driving circuit 101 (see FIG. 1A), and image signals D1, D2, . . . , Dn supplied from the data line driving circuit 101 are in turn supplied to the pixels P. The scanning lines 3a are connected to the scanning line driving circuits 102 (see FIG. 1A), and scanning signals SC1, SC2, . . . , SCm supplied from the scanning line driving circuits 102 are in turn supplied to the pixels P.

The image signals D1 to Dn supplied to the data lines 6a from the data line driving circuit 101 may be supplied line-sequentially in that order, or may be supplied in groups of a plurality of the data lines 6a that are adjacent to each other. The scanning line driving circuits 102 supply the scanning signals SC1 to SCm to the scanning lines 3a in pulses at a predetermined timing, in a line-sequential manner.

The liquid crystal device 100 is configured so that the TFTs 30 serving as switching elements turn on for a set period when the scanning signals SC1 to SCm are inputted thereto and the image signals D1 to Dn supplied from the data lines 6a are written into the pixel electrodes 15 at a predetermined timing as a result. The image signals D1 to Dn that have been written to the liquid crystal layer 50 at predetermined levels via the pixel electrodes 15 are then held for a set period between the pixel electrodes 15 and the common electrode 23 disposed facing the pixel electrodes 15 on another side of the liquid crystal layer 50.

To prevent the held image signals D1 to Dn from leaking, the storage capacitances 16 are connected in series to liquid crystal capacitors formed between the pixel electrodes 15 and the common electrode 23. Each storage capacitance 16 is provided between the drain of the corresponding TFT 30 and the capacitance line 3b.

Although FIG. 1A depicts a configuration in which the data lines 6a are connected to the examination circuit 103 and operational defects and the like can be confirmed in the liquid crystal device 100 by detecting the image signals during the process of manufacturing the liquid crystal device 100, the examination circuit 103 is not shown in the equivalent circuit illustrated in FIG. 2.

In this embodiment, the peripheral circuits that control the driving of the pixel circuits include the data line driving circuit 101, the scanning line driving circuits 102, and the examination circuit 103. The peripheral circuits may also include a sampling circuit that samples the image signals and supplies samples to the data lines 6a and a precharge circuit that supplies precharge signals at predetermined voltage levels to the data lines 6a prior to the image signals.

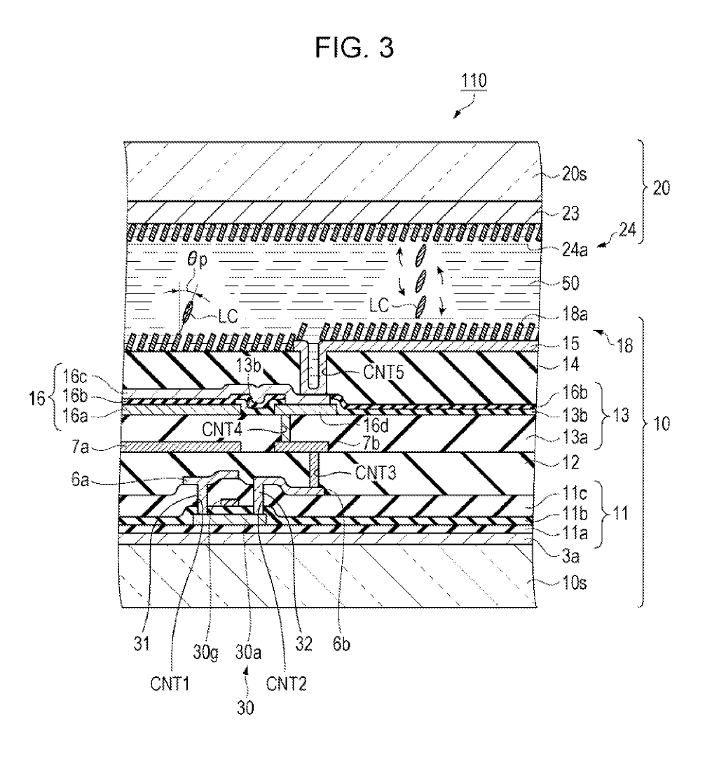

Next, the structure of the pixels P in the liquid crystal device 100 (the liquid crystal panel 110) according to this embodiment will be described. FIG. 3 is a cross-sectional view illustrating the overall structure of a pixel in the liquid crystal device according to the first embodiment.

As shown in FIG. 3, first, the scanning line 3a is formed on the substrate 10s of the element substrate 10. The scanning line 3a is configured of a metal element including at least one of Al (aluminum), Ti (titanium), Cr (chromium), W (tungsten), Ta (tantalum), Mo (molybdenum), and the like, an alloy, a metal silicide, a polysilicide, a nitride, or a layered combination thereof, and has light-blocking properties.

A first insulating film (a base insulating film) 11a configured of silicon oxide, for example, is formed so as to cover the scanning line 3a, and a semiconductor layer 30a is formed in an island shape on the first insulating film 11a. The semiconductor layer 30a is configured of a polycrystal silicon film, for example, into which ion impurities are injected, forming an LDD (lightly-doped drain) structure including a first source-drain region, a junction region, a channel region, a junction region, and a second source-drain region.

A second insulating film (gate insulator) 11b is formed so as to cover the semiconductor layer 30a. A gate electrode 30g is formed in a position that faces the channel region, with the second insulating film 11b located therebetween.

A third insulating film 11c is formed so as to cover the gate electrode 30g and the second insulating film 11b, and two contact holes CNT1 and CNT2 that pass through the second insulating film 11b and the third insulating film 11c are formed in positions corresponding to the respective end areas of the semiconductor layer 30a.

A source electrode 31 connected to the first source-drain region via the contact hole CNT1 is formed along with the data line 6a by forming a conductive film of a light-blocking conductive material such as Al (aluminum), an alloy thereof, or the like so as to coat the two contact holes CNT1 and CNT2 and cover the third insulating film 11c and patterning the conductive film. A drain electrode 32 (a first relay electrode 6b) connected to the second source-drain region via the contact hole CNT2 is formed at the same time.

Next, a first interlayer insulating film 12 is formed so as to cover the data line 6a as well as the first relay electrode 6b and the third insulating film 11c. The first interlayer insulating film 12 is configured of silicon oxide, nitride, or the like, and a planarizing process for planarizing non-planarities produced in the surface thereof when the region in which the TFT 30 is provided is covered is carried out thereon. Chemical mechanical polishing (CMP), spin coating, and so on can be given as examples of techniques used for the planarizing process.

A contact hole CNT3 that passes through the first interlayer insulating film 12 is formed in a position corresponding to the first relay electrode 6b. An interconnect 7a and a second relay electrode 7b electrically connected to the first relay electrode 6b via the contact hole CNT3 are formed by forming a conductive film of a light-blocking metal such as Al (aluminum), an alloy thereof, or the like so as to coat the contact hole CNT3 and cover the first interlayer insulating film 12 and patterning the conductive film.

The interconnect 7a is formed so as to overlap with the semiconductor layer 30a of the TFT 30, the data line 6a, and so on when viewed from above; a fixed potential is applied to the interconnect 7a, and thus the interconnect 7a functions as a shield layer.

A second interlayer insulating film 13a is formed so as to cover the interconnect 7a and the second relay electrode 7b. The second interlayer insulating film 13a can also be formed of silicon oxide, nitride, or the like, or an oxynitride, and a planarizing process such as CMP is carried out thereon.

A contact hole CNT4 is formed in the second interlayer insulating film 13a in a position corresponding to the second relay electrode 7b. A first capacitance electrode 16a and a third relay electrode 16d are formed by forming a conductive film of a light-blocking metal such as Al (aluminum), an alloy thereof, or the like so as to coat the contact hole CNT4 and cover the second interlayer insulating film 13a and patterning the conductive film.

An insulating film 13b is formed through patterning so as to cover an edge of the first capacitance electrode 16a in an area thereof that faces a second capacitance electrode 16c on another side of a dielectric layer 16b, which are formed later. In addition, the insulating film 13b is formed through patterning so as to cover edges of the third relay electrode 16d in areas aside from an area that overlaps with a contact hole CNT5.

The dielectric layer 16b is formed covering the insulating film 13b and the first capacitance electrode 16a. A silicon nitride film, a single-layer film such as hafnium oxide (HfO₂), alumina (Al₂O₂), tantalum oxide (Ta₂O₅), or the like, or a multilayer film in which at least two types of such single-layer films are stacked may be used as the dielectric layer 16b. The dielectric layer 16b is removed through etching or the like in an area thereof that overlaps with the third relay electrode 16d when viewed from above. The second capacitance electrode 16c is formed facing the first capacitance electrode 16a and connected to the third relay electrode 16d by forming a conductive film of TiN (titanium nitride), for example, so as to cover the dielectric layer 16b and patterning the conductive film. The storage capacitance 16 is configured of the dielectric layer 16b, the first capacitance electrode 16a disposed facing the second capacitance electrode 16c with the dielectric layer 16b therebetween, and the second capacitance electrode 16c.

Next, a third interlayer insulating film 14 is formed so as to cover the second capacitance electrode 16c and the dielectric layer 16b. The third interlayer insulating film 14 can also be formed of silicon oxide, nitride, or the like, and a planarizing process such as CMP is carried out thereon. The contact hole CNT5 is formed passing through the third interlayer insulating film 14 so as to reach an area in which the second capacitance electrode 16c makes contact with the third relay electrode 16d.

A transparent conductive film (electrode film) configured of ITO, for example, is deposed so as to coat the contact hole CNT5 and cover the third interlayer insulating film 14. The pixel electrode 15 that is electrically connected to the second capacitance electrode 16c and the third relay electrode 16d via the contact hole CNT5 is formed by patterning this transparent conductive film (electrode film).

The second capacitance electrode 16c is electrically connected to the drain electrode 32 of the TFT 30 via the third relay electrode 16d, the contact hole CNT4, the second relay electrode 7b, the contact hole CNT3, and the first relay electrode 6b, and is electrically connected to the pixel electrode 15 via the contact hole CNT5.

The first capacitance electrode 16a is formed so as to span across a plurality of the pixels P, and functions as the capacitance line 3b in the equivalent circuit (see FIG. 2). A fixed potential is applied to the first capacitance electrode 16a. Through this, a potential applied to the pixel electrode 15 via the drain electrode 32 of the TFT 30 can be held between the first capacitance electrode 16a and the second capacitance electrode 16c.

A plurality of wires are formed on the substrate 10s of the element substrate 10, and a wire layer is indicated by the reference numerals of insulating films, interlayer insulating films, and so on that provide insulation between the wires. In other words, the first insulating film 11a, the second insulating film 11b, and the third insulating film 11c are collectively referred to as a wire layer 11. The representative wire in the wire layer 11 is the scanning line 3a. The representative wire in a wire layer 12 is the data line 6a. The second interlayer insulating film 13a, the insulating film 13b, and the dielectric layer 16b are collectively referred to as a wire layer 13, and the representative wire in the wire layer 13 is the interconnect 7a. Likewise, the representative wire in a wire layer 14 is the first capacitance electrode 16a (the capacitance line 3b).

The orientation layer 18 is formed so as to cover the pixel electrode 15, and the orientation layer 24 is formed so as to cover the common electrode 23 in the opposing substrate 20 disposed facing the element substrate 10 on another side of the liquid crystal layer 50. As described earlier, the orientation layers 18 and 24 are inorganic orientation layers, and are collections of columns 18a and 24a, respectively, in which an inorganic material such as silicon oxide is deposed in column form at an angle from a predetermined direction, for example. Liquid crystal molecules LC having negative dielectric anisotropy relative to the orientation layers 18 and 24 are aligned substantially vertically (vertical alignment, or VA) at a pretilt angle θp of 3 to 5 degrees in the angled direction of the columns 18a and 24a relative to the normal direction of the orientation layer surfaces. When the liquid crystal layer 50 is driven by applying an AC voltage between the pixel electrode 15 and the common electrode 23, the liquid crystal molecules LC behave (vibrate) so as to sway in the direction of an electrical field produced between the pixel electrode 15 and the common electrode 23.

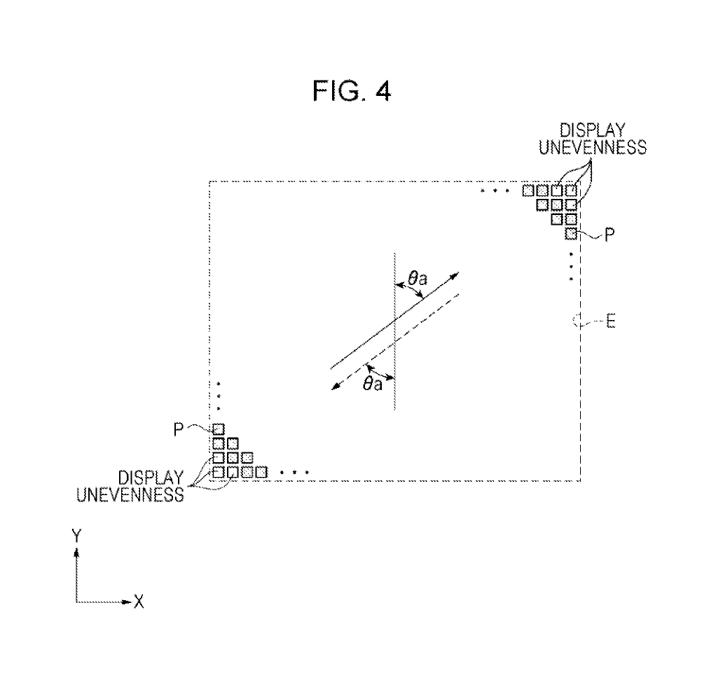

FIG. 4 is a plan view illustrating an overview of a relationship between an angled deposition direction of an inorganic material and display problems caused by ionic impurities. As shown in FIG. 4, the angled deposition direction of the inorganic material where the columns 18a and 24a are formed is, for example in the element substrate 10, a direction that intersects with the Y direction from the upper-right to the lower-left at a predetermined angle of direction θa, as indicated by a broken line arrow. In the opposing substrate 20 that faces the element substrate 10, the angled deposition direction is a direction that intersects with the Y direction from the lower-left to the upper-right at the predetermined angle of direction θa, as indicated by a solid line arrow. The predetermined angle θa is 45 degrees, for example. Note that the angled deposition direction shown in FIG. 4 is a direction found when viewing the liquid crystal device 100 from the side on which the opposing substrate 20 is disposed.

When the liquid crystal layer 50 is driven and the liquid crystal molecules LC behave (vibrate) as a result, the liquid crystal molecules LC flow, in the angled deposition direction indicated by the broken or solid line arrows shown in FIG. 4, near the borders between the liquid crystal layer 50 and the orientation layers 18 and 24. However, if the liquid crystal layer 50 contains positive or negative-polarity ionic impurities, the ionic impurities will move toward the corners of the pixel region E along with the flow of the liquid crystal molecules LC, becoming possibly localized in the corners. The localization of the ionic impurities leads to a drop in the insulation resistance of the liquid crystal layer 50 in the pixels P located in the corners, which in turn leads to a drop in the driving potential of those pixels P; as a result, display unevenness, burn-in due to electrification, and so on will become prominent, as indicated in FIG. 4. Inorganic orientation layers are particularly susceptible to attracting ionic impurities, and thus such display unevenness, burn-in, and so on will be more prominent when inorganic orientation layers are used for the orientation layers 18 and 24 as opposed to organic orientation layers.

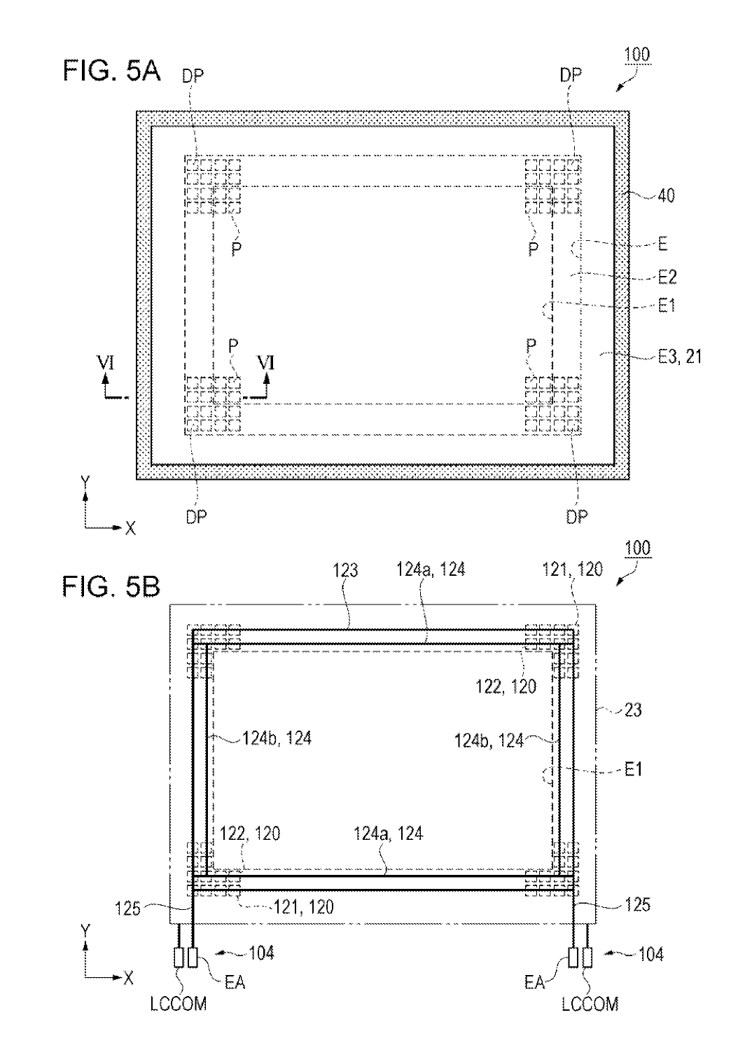

The liquid crystal device 100 according to this embodiment ameliorates display unevenness, burn-in, and the like as indicated in FIG. 4 by employing, in the pixel region E, a plurality of dummy pixels that surround the plurality of pixels P actually active in the display and that function as an electricity parting portion, and employing the electricity parting portion as an ion trapping portion. The electricity parting portion according to this embodiment will be described hereinafter with reference to FIGS. 5A to 7.

FIG. 5A is a plan view illustrating an overview of an arrangement of active display pixels and dummy pixels;

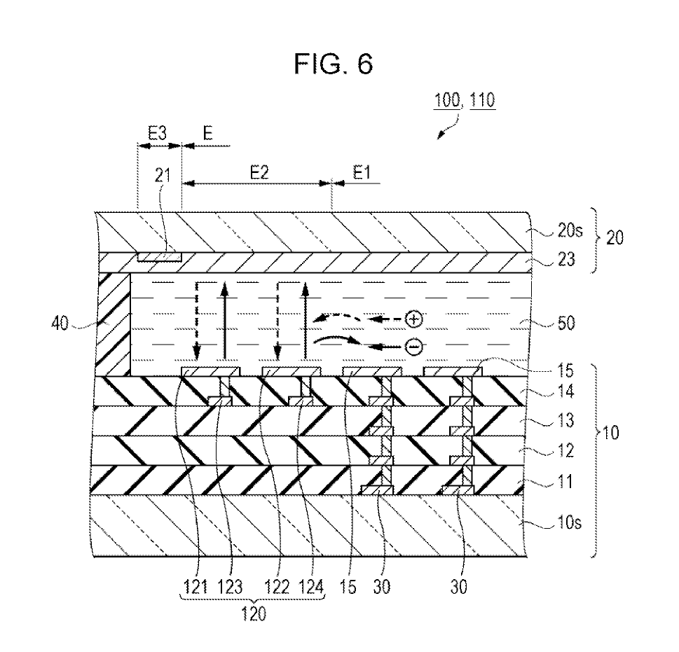

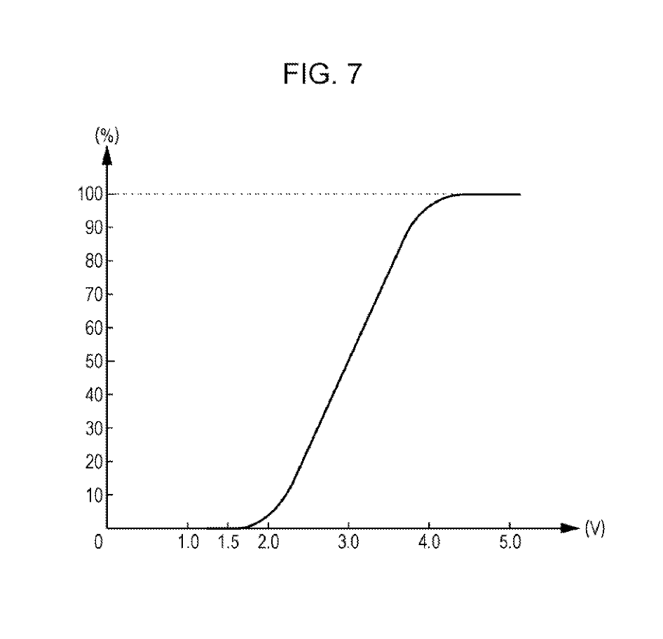

FIG. 5B is a wiring diagram illustrating the electricity parting portion; FIG. 6 is a cross-sectional view, taken along a VI-VI line in FIG. 5A, illustrating an overview of the structure of the liquid crystal panel; and FIG. 7 is a graph illustrating a relationship between a transmissibility and a driving voltage of the pixels in the liquid crystal device according to the first embodiment.

As shown in FIG. 5A, the pixel region E in the liquid crystal device 100 according to this embodiment includes a display region E1 in which the active display pixels P are disposed and a dummy pixel region E2 that surrounds the display region E1 and in which a plurality of dummy pixels DP are disposed. The parting portion 21, which has light-blocking properties as described earlier, is provided between the frame-shaped region in which the sealant 40 is disposed and the dummy pixel region E2, and the region in which the parting portion 21 is disposed corresponds to a parting region E3 that operates regardless of whether the liquid crystal device 100 is on or off. The display region E1 corresponds to a first region according to the invention, whereas the dummy pixel region E2 corresponds to a second region according to the invention.

Sets of two dummy pixels DP are disposed in the dummy pixel region E2 on both sides of the display region E1 in both the X direction and the Y direction. Note that the number of dummy pixels DP disposed in the dummy pixel region E2 is not limited thereto, and any number may be used as long as there is at least one dummy pixel DP on both sides of the display region E1 in both the X direction and the Y direction. There may be three or more dummy pixels DP, and the number of dummy pixels DP may differ between the X direction and the Y direction. In this embodiment, the dummy pixels DP function as the electricity parting portion, and thus reference numeral 120 will be given to the plurality of dummy pixels DP and the dummy pixels DP will be referred to as an electricity parting portion 120.

As shown in FIG. 5B, each of the plurality of dummy pixels DP that surround the display region E1, are disposed along the edge of the display region E1, and are disposed in locations closer to the display region E1, has a dummy pixel electrode 122. Meanwhile, each of the plurality of dummy pixels DP that are disposed along the edge of the display region E1 and are disposed in locations farther from the display region E1 than the dummy pixel electrodes 122 has a dummy pixel electrode 121. A plurality of the dummy pixel electrodes 121 and a plurality of the dummy pixel electrodes 122 disposed along the X direction are disposed adjacent to each other in the Y direction, whereas the plurality of dummy pixel electrodes 121 and the plurality of dummy pixel electrodes 122 disposed along the Y direction are disposed adjacent to each other in the X direction. In other words, the electricity parting portion 120 includes the plurality of dummy pixel electrodes 121 and 122 disposed in the X direction and the Y direction, respectively. In addition, the electricity parting portion 120 includes a connection wire 123 that electrically connects the plurality of dummy pixel electrodes 121 to each other and a connection wire 124 that electrically connects the plurality of dummy pixel electrodes 122 to each other. The connection wire 124 includes a pair of wires 124a that extend in the X direction, electrically connect the plurality of dummy pixel electrodes 122 disposed in the X direction, and are electrically connected to the connection wire 123 and a wire 124b that extends in the Y direction and electrically connects the plurality of dummy pixel electrodes 122 disposed in the Y direction.

One end of each wire in a pair of routing wires 125 extending in the Y direction is electrically connected to lower-left and lower-right corners of the connection wire 123 that forms a quadrangle when viewed from above. The other ends of the respective routing wires 125 are connected to the external connection terminals 104 in the element substrate 10. The external connection terminals 104 to which the pair of routing wires 125 are connected will be distinguished from the other external connection terminals 104 as external connection terminals 104 (EA). The common electrode 23 in the opposing substrate 20 is electrically connected to the external connection terminals 104 adjacent to the external connection terminals 104 (EA). A common potential (LCCOM) is applied to the common electrode 23. Accordingly, the external connection terminals 104 electrically connected to the common electrode 23 are referred to as external connection terminals 104 (LCCOM).

The electricity parting portion 120 includes the plurality of dummy pixel electrodes 121 and 122, the connection wires 123 and 124 for applying a predetermined potential supplied from the external connection terminals 104 (EA) to the plurality of dummy pixel electrodes 121 and 122, and the pair of routing wires 125.

Of the dummy pixel electrodes 121 and 122 and the common electrode 23 that face each other on opposite sides of the liquid crystal layer 50 in the dummy pixel region E2, the dummy pixel electrodes 121 and 122 correspond to a first electrode according to the invention, and part of the common electrode 23 corresponds to a second electrode according to the invention.

Although this embodiment is configured so that a predetermined potential is supplied from the two external connection terminals 104 (EA) in order to suppress the predetermined potential applied to the plurality of dummy pixel electrodes 121 and 122 from varying depending on the positions of the dummy pixel electrodes 121 and 122 in the element substrate 10, the configuration is not limited thereto. One, or three or more, external connection terminals 104 (EA) may be employed instead.

Next, electrical functionality of the electricity parting portion 120 will be described with reference to FIG. 6. Note that the orientation layer 18 on the element substrate 10 side and the orientation layer 24 on the opposing substrate 20 side are not shown in FIG. 6.

As shown in FIG. 6, the element substrate 10 of the liquid crystal panel 110 (the liquid crystal device) includes a plurality of wire layers 11 to 14 on the substrate 10s. The pixel electrodes 15 of the pixels P and the dummy pixel electrodes 121 and 122 of the dummy pixels DP are formed upon the third interlayer insulating film 14. The dummy pixel electrodes 121 and 122 are formed using the same transparent conductive film as the pixel electrodes 15 (an ITO film, for example) when forming the pixel electrodes 15. When viewed from above, the shape and size of the dummy pixel electrodes 121 and 122, the pitch at which the dummy pixel electrodes 121 and 122 are disposed, and so on are the same as for the pixel electrodes 15. The connection wires 123 and 124 for supplying the predetermined potential to the dummy pixel electrodes 121 and 122 are formed in the wire layer 14. In other words, the connection wires 123 and 124 are formed using the same conductive film as the first capacitance electrode 16a (for example, an alloy of Al and Ti) when, for example, the aforementioned first capacitance electrode 16a is formed. The dummy pixel electrodes 121 and 122 and the connection wires 123 and 124 are electrically connected, respectively, via the conductive films in the contact holes that pass through the third interlayer insulating film 14.

Note that the connection wires 123 and 124 are not limited to being formed in the wire layer 14, and may be formed in a lower wire layer than the wire layer 14.

### Driving Method of Liquid Crystal Device 100

During a display period, image signals (AC potentials) corresponding to the tone levels of an image are applied to the pixel electrodes 15, using the potential of the common electrode 23 as a reference. Meanwhile, AC potentials that shift between a high potential and a low potential relative to the potential of the common electrode 23 are applied to the dummy pixel electrodes 121 and 122 via the connection wires 123 and 124. If the potentials of the dummy pixel electrodes 121 and 122 are higher than the potential of the common electrode 23, an electrical field oriented from the common electrode 23 toward the dummy pixel electrodes 121 and 122, as indicated by the broken line arrow, is produced. Likewise, if the potentials of the dummy pixel electrodes 121 and 122 are lower than the potential of the common electrode 23, an electrical field oriented from the dummy pixel electrodes 121 and 122 toward the common electrode 23, as indicated by the solid line arrow, is produced.

An electrical field indicated by the broken line arrow or the solid line arrow is produced in accordance with the potentials between the pixel electrodes 15 and the dummy pixel electrodes 122 which are adjacent to each other at the border between the display region E1 and the dummy pixel region E2.

In this embodiment, an AC voltage that is lower than a threshold voltage at which the transmissibility of the liquid crystals changes is applied between the external connection terminals 104 (LCCOM) and the external connection terminals 104 (EA).

Specifically, the liquid crystal device 100 according to this embodiment employs a VA-type normally-black mode optical design using an inorganic orientation layer, as described earlier. Accordingly, the transmissibility of the pixels P and the driving voltage in the liquid crystal device 100 are in a relationship in which the transmissibility is taken as 0% when no driving voltage is applied between the pixel electrodes 15 and the common electrode 23 and the transmissibility is taken as 100% when a predetermined driving voltage is applied between the pixel electrodes 15 and the common electrode 23. For example, in the case where liquid crystals having negative dielectric anisotropy are used and a dielectric constant ∈// is 4.0, a dielectric constant ∈⊥ is 8.5, an elastic constant k1 is 15 pN, an elastic constant k2 is 16 pN, and an elastic constant k3 is 17 pN, the transmissibility will begin to change when an effective voltage applied between the pixel electrodes 15 and the common electrode 23 exceeds 2.0 V, as shown in FIG. 7. The effective voltage at which the transmissibility begins to change in this manner is called the “threshold voltage”.

In this embodiment, a voltage that is lower than the threshold voltage (2 V), such as a voltage of 1.5 V, is applied between the dummy pixel electrodes 121 and 122 and the common electrode 23. More specifically, the AC potential applied to the dummy pixel electrodes 121 and 122 is based on the potential of the common electrode 23, and thus when a common potential (LCCOM) applied to the common electrode 23 is set to 6 V, for example, the potential of the dummy pixel electrodes 121 and 122 fluctuates in the range between 4.5 V to 7.5 V.

During the display period, the frequency of the image signals (AC voltages) applied between the pixel electrodes 15 and the common electrode 23 is 60 Hz, for example, and it is preferable for the frequency of the AC voltage applied between the dummy pixel electrodes 121 and 122 and the common electrode 23 to be the same as the frequency of the image signals.

A lower voltage than the threshold voltage is applied between the dummy pixel electrodes 121 and 122 and the common electrode 23, and thus the transmissibility in the dummy pixel region E2 experiences almost no change, remaining black (that is, in a state of 0% transmissibility). Through this, the plurality of dummy pixels DP function as the electricity parting portion 120.

On the other hand, if the liquid crystal layer 50 contains positive-polarity (+) or negative-polarity (−) ionic impurities, the ionic impurities will be conveyed to the corners of the display region E1 as the liquid crystal device 100 is driven, as mentioned earlier. The ionic impurities will then be pulled by the electrical field produced between the dummy pixel electrodes 121 and 122 and the common electrode 23 located around the corners thereof, and will be swept into the dummy pixel region E2 from the display region E1.

According to the first embodiment described thus far, the following effects are achieved.

1. According to the liquid crystal device 100 and the driving method thereof, an AC voltage that is lower than the threshold voltage at which the transmissibility of the pixels P changes is applied between the dummy pixel electrodes 121 and 122 in the dummy pixel region E2 that surrounds the display region E1 and the common electrode 23, using the potential of the common electrode 23 as a reference. Accordingly, the dummy pixels DP including the dummy pixel electrodes 121 and 122 can function as the electricity parting portion 120 and ionic impurities can be swept from the display region E1 to the dummy pixel region E2. In other words, display problems such as display unevenness, burn-in, and the like caused by ionic impurities localizing in the display region E1 are ameliorated.

2. During the display period, the frequency of the AC voltages applied between the dummy pixel electrodes 121 and 122 and the common electrode 23 is the same as the frequency of the image signals applied between the pixel electrodes 15 and the common electrode 23, and thus it is not necessary to generate AC voltages at different frequencies from the image signals, which avoids complicating the configuration of an external driving circuit that drives the liquid crystal device 100.

Although the aforementioned first embodiment describes applying an AC voltage between the dummy pixel electrodes 121 and 122 and the common electrode 23, the configuration is not limited thereto. It is known that positive-polarity cations are prevalent in ionic impurities that are likely to be present in the liquid crystal layer 50. In light of this, a DC potential that is lower than the potential of the common electrode 23 may be applied to the dummy pixel electrodes 121 and 122, using the potential of the common electrode 23 as a reference. If the potential of the common electrode 23 is 6 V, for example, a 4.5 V DC potential is applied to the dummy pixel electrodes 121 and 122. Alternatively, if the potential of the common electrode 23 is 0 V, for example, a −1.5 V DC potential is applied to the dummy pixel electrodes 121 and 122. Through this, the effective DC voltage applied between the dummy pixel electrodes 121 and 122 and the common electrode 23 is lower than the threshold voltage and the dummy pixel electrodes 121 and 122 can be caused to function as the electricity parting portion 120; furthermore, positive-polarity ionic impurities (cations) can be effectively swept from the display region E1 to the dummy pixel region E2 in which the electricity parting portion 120 is provided.

Meanwhile, the application of the AC voltage or DC voltage between the dummy pixel electrodes 121 and 122 and the common electrode 23 is not limited to the display period, and may continue even after the display period has ended. In particular, the AC voltage or DC voltage applied between the dummy pixel electrodes 121 and 122 and the common electrode 23 may be set to the same voltage as the threshold voltage or a voltage that is higher than the threshold voltage after the display period has ended. In other words, a voltage that is higher than or equal to the threshold voltage can be applied between the dummy pixel electrodes 121 and 122 and the common electrode 23 after the end of the display period regardless of the display state of the display region E1, making it possible to more effectively sweep the ionic impurities to the dummy pixel region E2.

### Second Embodiment

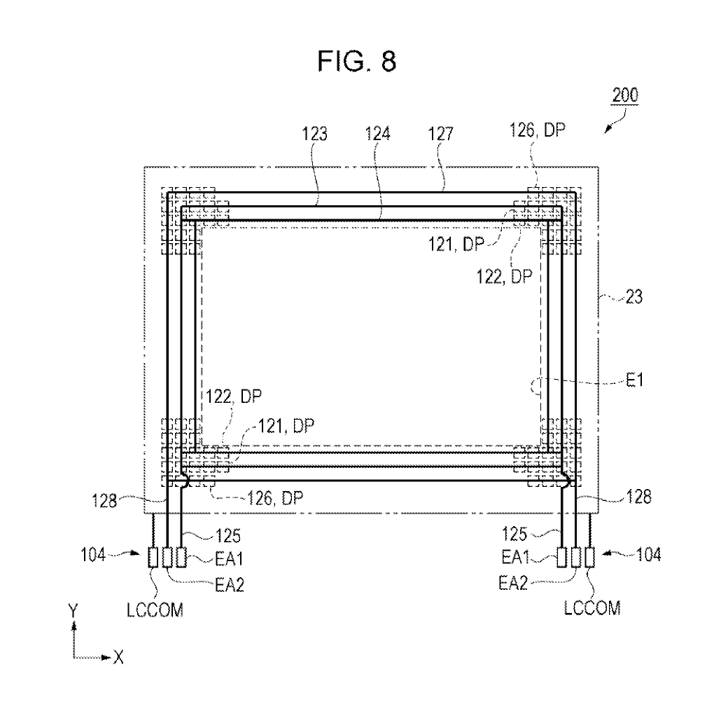

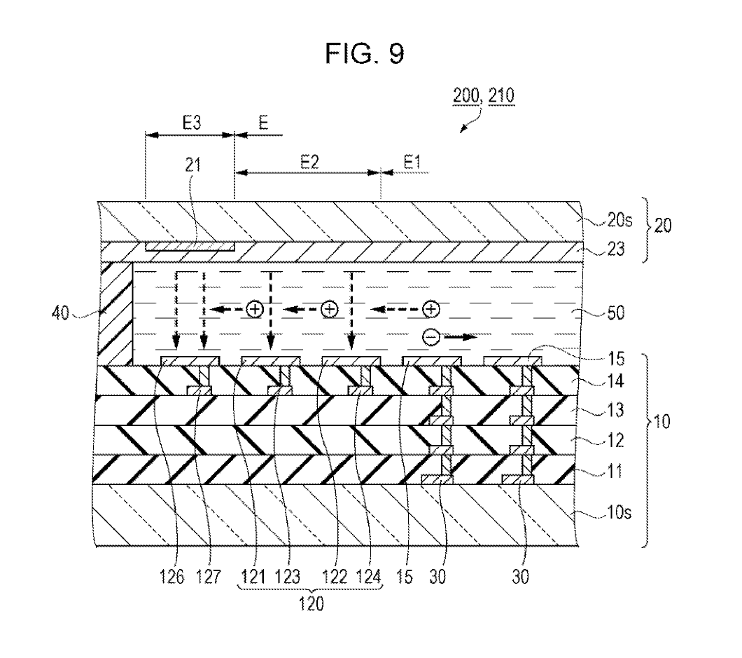

Next, a liquid crystal device according to a second embodiment will be described with reference to FIGS. 8 and 9. FIG. 8 is a wiring diagram illustrating the configuration of an electricity parting portion in the liquid crystal device according to the second embodiment, and FIG. 9 is a cross-sectional view illustrating the overall structure of the liquid crystal device according to the second embodiment. In the liquid crystal device according to the second embodiment, the manner in which the dummy pixels DP are disposed is different from the liquid crystal device 100 according to the first embodiment. Accordingly, constituent elements that are the same as those in the liquid crystal device 100 according to the first embodiment are given the same reference numerals, and detailed descriptions thereof will be omitted; the descriptions will instead focus on areas that differ from the liquid crystal device 100 according to the first embodiment.

A liquid crystal device 200 according to this embodiment employs a normally-black mode optical design. As shown in FIG. 8, in the liquid crystal device 200 (liquid crystal panel 210) according to this embodiment, the dummy pixel electrodes 122, the dummy pixel electrodes 121, and dummy pixel electrodes 126 are disposed in positions surrounding the display region E1, in that order from the display region E1. In other words, three dummy pixels DP are provided on each side of the display region E1 in the X direction and the Y direction. The connection wire 123 that electrically connects the plurality of dummy pixel electrodes 121 to each other and the connection wire 124 that electrically connects the plurality of dummy pixel electrodes 122 to each other and is electrically connected to the connection wire 123 are provided. Meanwhile, a connection wire 127 that electrically connects the plurality of dummy pixel electrodes 126 disposed on the outer side of the plurality of dummy pixel electrodes 121 to each other is provided as well. The dummy pixel electrodes 126 correspond to a third electrode according to the invention. When viewed from above, the shape and size of the dummy pixel electrodes 126 are the same as those of the pixel electrodes 15.

The connection wire 123 is electrically connected to external connection terminals 104 (EA1) by the pair of routing wires 125 extending in the Y direction. The connection wire 123 and the connection wire 127 are electrically isolated, and the connection wire 127 is electrically connected to external connection terminals 104 (EA2) by a pair of routing wires 128 extending in the Y direction. The external connection terminals 104 (EA1) and the external connection terminals 104 (EA2) are adjacent to each other, and the external connection terminals 104 (LCCOM) electrically connected to the common electrode 23 are further disposed adjacent to corresponding external connection terminals 104 (EA2).

A negative-polarity DC potential (that is lower than the common potential) is supplied to the external connection terminals 104 (EA1) and the external connection terminals 104 (EA2), using the common potential supplied to the external connection terminals 104 (LCCOM) as a reference.

As shown in FIG. 9, the dummy pixel electrodes 126 serving as the third electrode are formed upon the third interlayer insulating film 14, in the same manner as the dummy pixel electrodes 121 and 122 and the pixel electrodes 15. In other words, the dummy pixel electrodes 126 are formed using the same transparent conductive film as the pixel electrodes 15 when forming the pixel electrodes 15. Furthermore, the dummy pixel electrodes 126 are formed in the parting region E3 when viewed from above. Accordingly, light is blocked from the dummy pixel electrodes 126 by the parting portion 21.

The connection wire 127 that supplies the predetermined potential to the dummy pixel electrodes 126 is formed in the wire layer 14. In other words, the connection wire 126 is formed using the same conductive film as the first capacitance electrode 16a when, for example, the aforementioned first capacitance electrode 16a is formed in the wire layer 14. Note that the connection wire 127 is not limited to being formed in the wire layer 14, and may be formed in a lower wire layer than the wire layer 14.

### Driving Method of Liquid Crystal Device 200

During the display period, a negative-polarity DC potential that is lower than the threshold voltage is applied to the dummy pixel electrodes 121 and 122 that function as the electricity parting portion 120, using the potential of the common electrode 23 (LCCOM) as a reference. A negative-polarity DC potential that is higher than the negative-polarity DC potential applied to the dummy pixel electrodes 121 and 122 is applied to the dummy pixel electrodes 126 serving as the third electrode.

As a result, an electrical field oriented from the common electrode 23 toward the dummy pixel electrodes 121 and 122 is produced between the common electrode 23 and the dummy pixel electrodes 121 and 122. Furthermore, a stronger electrical field than the electrical field between the common electrode 23 and the dummy pixel electrodes 121 and 122 is produced, in the direction from the common electrode 23 toward the dummy pixel electrodes 126.

Accordingly, in the case where the liquid crystal layer 50 contains positive-polarity (+) ionic impurities (cations), the positive-polarity ionic impurities are swept from the display region E1 to the dummy pixel region E2, and the positive-polarity ionic impurities swept to the dummy pixel region E2 are further swept to the parting region E3. In other words, positive-polarity ionic impurities can be suppressed from accumulating and remaining in the electricity parting portion 120 that includes the dummy pixel electrodes 121 and 122. On the other hand, negative-polarity (−) ionic impurities (anions) are pushed toward the display region E1 by the electrical field produced in the electricity parting portion 120. In other words, negative-polarity ionic impurities can be suppressed from remaining and concentrating near the border between the display region E1 and the dummy pixel region E2.

According to the second embodiment described thus far, the following effects are achieved.

1. According to the liquid crystal device 200 and the driving method thereof, the plurality of dummy pixel electrodes 126 are provided in the parting region E3, and a negative-polarity DC potential that is higher than the potential of the dummy pixel electrodes 121 and 122 that function as the electricity parting portion 120 is applied to the dummy pixel electrodes 126. Accordingly, the positive-polarity ionic impurities swept to the dummy pixel region E2 can be further swept to the parting region E3 on the outer side of the dummy pixel region E2. As a result, the influence of positive-polarity ionic impurities remaining in the dummy pixel region E2 surrounding the display region E1 on the display in the display region E1 can be reduced.

2. The dummy pixel electrodes 126 are disposed on the parting region E3, and thus leaking light produced when the negative-polarity DC potential is applied to the dummy pixel electrodes 126 is blocked by the parting portion 21; accordingly, such leaking light has no influence on the display quality in the display region E1.

Note that a negative-polarity DC voltage that is the same as the threshold voltage or higher than the threshold voltage may be applied between the dummy pixel electrodes 121, 122, and 126 and the common electrode 23 after the display period has ended.

### Third Embodiment

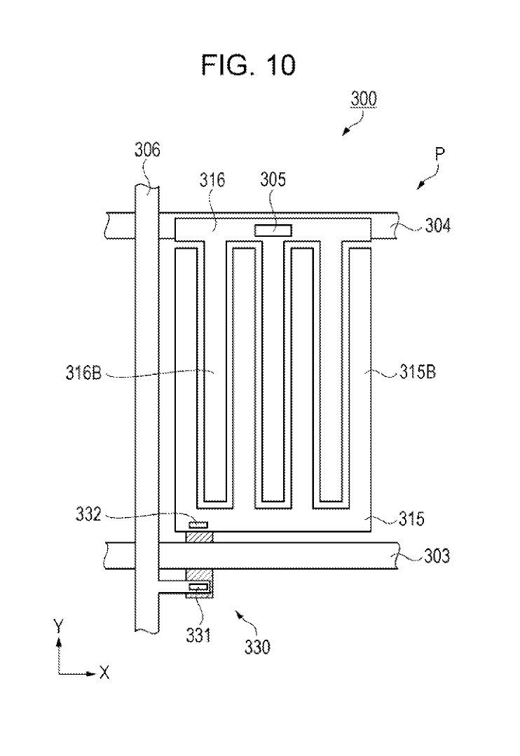

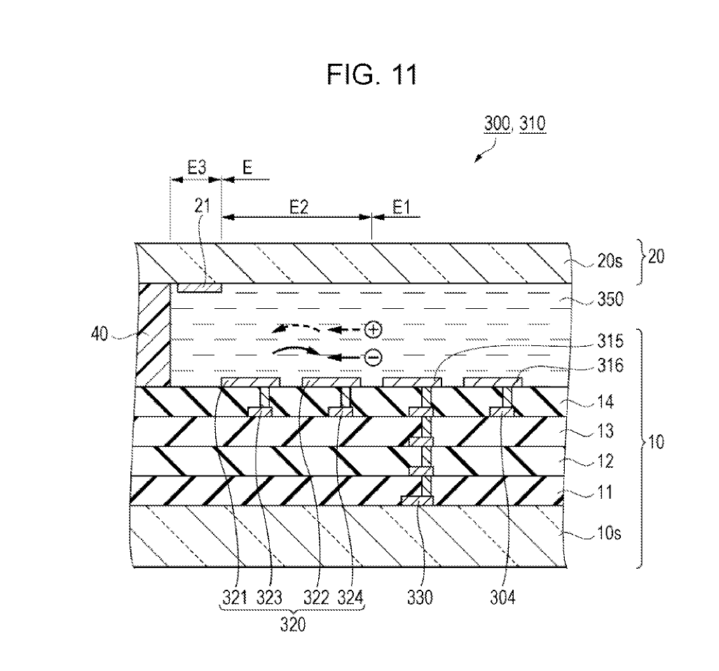

Next, a liquid crystal device according to a third embodiment will be described with reference to FIGS. 10 and 11. FIG. 10 is a plan view illustrating the overall configuration of the pixel in a liquid crystal device according to the third embodiment, and FIG. 11 is a cross-sectional view illustrating the overall structure of an electricity parting portion in the liquid crystal device according to the third embodiment. Note that FIG. 11 is a general cross-sectional view corresponding to that shown in FIG. 6 and described in the first embodiment.

In the liquid crystal device according to the third embodiment, the structure of the pixels P is different from the liquid crystal device 100 according to the first embodiment. Accordingly, constituent elements that are the same as those in the liquid crystal device 100 according to the first embodiment are given the same reference numerals, and detailed descriptions thereof will be omitted.

A liquid crystal device 300 according to this embodiment employs a normally-black mode optical design. As shown in FIG. 10, the liquid crystal device 300 includes scanning lines 303 that extend in the X direction, common wires 304 that extend in the X direction and are parallel to the scanning lines 303, and data lines 306 that extend in the Y direction. The liquid crystal device 300 also includes a thin-film transistor 330 provided near the areas where the scanning lines 303 and data lines 306 intersect, a comb-tooth shape pixel electrode 315, and a corresponding comb-tooth shape common electrode 316, for each of the pixels P. A semiconductor layer of the thin-film transistor 330 is disposed along the Y direction so as to intersect with the scanning line 303 that extends in the X direction, and the portion of the scanning line 303 that intersects with the semiconductor layer functions as a gate electrode. In other words, the thin-film transistor 330 has a top-gate structure.

The semiconductor layer of the thin-film transistor 330 has an LDD structure, where the data line 306 is connected to a first source-drain region via a contact portion 331 and the pixel electrode 315 is connected to a second source-drain region via a contact portion 332.

The pixel electrode 315 and the common electrode 316 are disposed so that branch electrodes 316B of the common electrode 316 are positioned between branch electrodes 315B of the pixel electrode 315. The common electrode 316 is connected to the common wire 304 to which the common potential (LCCOM) is supplied via a contact portion 305.

As shown in FIG. 11, a liquid crystal panel 310 of the liquid crystal device 300 includes a liquid crystal layer 350 interposed between the element substrate 10 that has the plurality of wire layers 11 to 14 provided upon the substrate 10s and the opposing substrate 20 disposed facing the element substrate 10 on another side of the sealant 40. The liquid crystal layer 350 contains liquid crystal molecules having positive dielectric anisotropy, for example, and the liquid crystal molecules are oriented approximately horizontally. An orientation layer that orients the liquid crystal molecules approximately horizontally is not shown in FIG. 11. The orientation layer is configured by, for example, rubbing a polyimide film in a predetermined direction.

The liquid crystal panel 310 includes the display region E1 in which the pixels P having the pixel electrode 315 and the common electrode 316 are arranged, the dummy pixel region E2 that surrounds the display region E1, and the parting region E3 that surrounds the dummy pixel region E2. The parting portion 21 is provided in the parting region E3, on the side of the opposing substrate 20 located toward the liquid crystal layer 350.

In the display region E1, the pixel electrode 315 and the common electrode 316 are formed upon the third interlayer insulating film 14 using a transparent conductive film such as ITO. The common wire 304 to which the common electrode 316 is connected is formed in the wire layer 14. A horizontal electrical field is produced by applying an AC voltage between the pixel electrode 315 and the common electrode 316, using the potential of the common electrode 316 as a reference, and light passing through the pixels P can be modulated based on image signals by changing the orientation direction of the horizontally-oriented liquid crystal molecules to the direction of the electrical field. The display technique that employs horizontal electrical fields produced between the pixel electrode 315 and the common electrode 316 formed in the same layer in this manner is referred to as the IPS (in-plane switching) technique.

In this embodiment, a first electrode 321 and a second electrode 322 are provided in the dummy pixel region E2. The first electrode 321 and the second electrode 322 are formed using the same transparent conductive film when the pixel electrode 315, the common electrode 316, and so on are formed. Together, the first electrode 321 and the second electrode 322 configure a single dummy pixel.

Connection wires 323 and 324 are formed in the wire layer 14, in the same layer as the common wire 304 and using the same conductive film. The connection wire 323 is electrically connected to the first electrode 321, and the connection wire 324 is electrically connected to the second electrode 322. Note that the common wire 304 and the connection wires 323 and 324 are not limited to being formed in the wire layer 14, and may be formed in a lower wire layer than the wire layer 14.

### Driving Method of Liquid Crystal Device 300

The same common potential (LCCOM) as that supplied to the common wire 304 is supplied to the second electrode 322 via the connection wire 324. An AC potential that shifts between a higher potential and a lower potential relative to the potential of the second electrode 322 is supplied to the first electrode 321 via the connection wire 323. In other words, an AC voltage is applied between the first electrode 321 and the second electrode 322, using the potential of the second electrode 322 as a reference. This AC voltage is lower than the threshold voltage at which the transmissibility of the pixels P changes. As a result, the dummy pixels that each include the first electrode 321 and the second electrode 322 function as an electricity parting portion 320. Meanwhile, ionic impurities (cations and anions) present in the liquid crystal layer 350 are pulled toward the first electrode 321 by the horizontal electrical field produced between the first electrode 321 and the second electrode 322. In other words, ionic impurities (cations and anions) can be swept from the display region E1 to the dummy pixel region E2.

Note that the frequency of the AC voltage applied between the first electrode 321 and the second electrode 322 is the same as the frequency of the AC voltage applied between the pixel electrode 315 and the common electrode 316, and is 60 Hz, for example.

Furthermore, the AC voltage applied between the first electrode 321 and the second electrode 322 may be set to the same voltage as the threshold voltage or a voltage that is higher than the threshold voltage after the display period has ended.

According to this embodiment, the electricity parting portion 320 that includes the first electrode 321 and the second electrode 322 produces a horizontal electrical field in the same manner as the pixels P, but because the AC voltage applied between the first electrode 321 and the second electrode 322 is lower than the threshold voltage, the dummy pixel region E2 is kept in the normally-black display state. Accordingly, the electricity parting portion 320 that is not only capable of pulling ionic impurities but that also has superior view angle properties, in which leaking light is not apparent even when viewed from an angle, can be realized.

### Fourth Embodiment

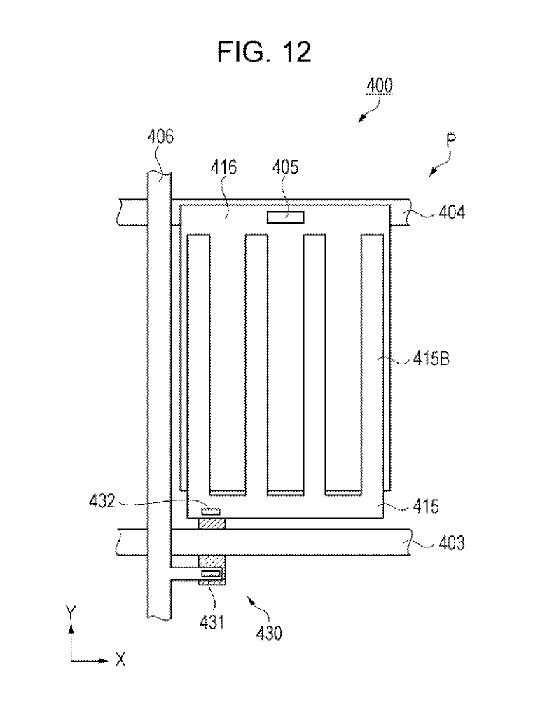

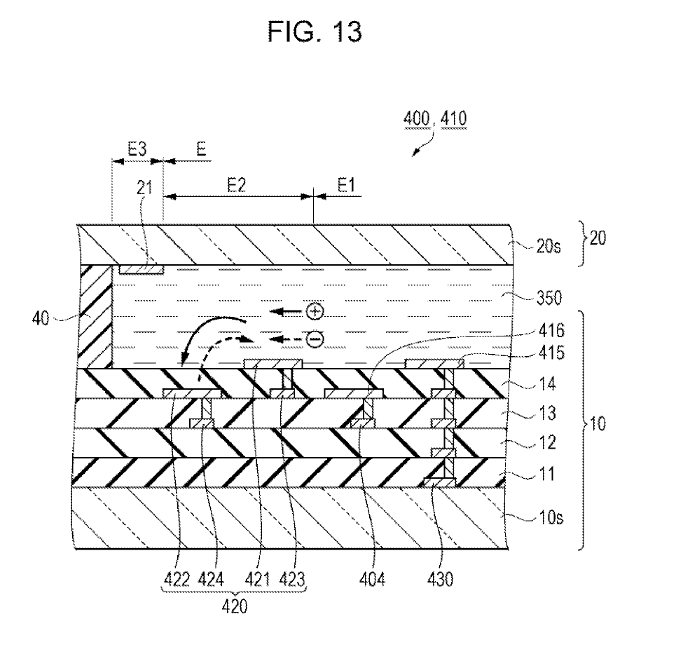

Next, a liquid crystal device according to a fourth embodiment will be described with reference to FIGS. 12 and 13. FIG. 12 is a plan view illustrating the overall configuration of a pixel in the liquid crystal device according to the fourth embodiment, and FIG. 13 is a cross-sectional view illustrating the overall structure of an electricity parting portion in the liquid crystal device according to the fourth embodiment. Note that FIG. 13 is a general cross-sectional view corresponding to that shown in FIG. 6 and described in the first embodiment.

In the liquid crystal device according to the fourth embodiment, the structure of the pixels P is different from the liquid crystal device 100 according to the first embodiment. Accordingly, constituent elements that are the same as those in the liquid crystal device 100 according to the first embodiment are given the same reference numerals, and detailed descriptions thereof will be omitted.

A liquid crystal device 400 according to this embodiment employs a normally-black mode optical design. As shown in FIG. 12, the liquid crystal device 400 includes scanning lines 403 that extend in the X direction, common wires 404 that extend in the X direction and are parallel to the scanning lines 403, and data lines 406 that extend in the Y direction. The liquid crystal device 400 also includes a thin-film transistor 430 provided near the areas where the scanning lines 403 and data lines 406 intersect, a comb-tooth shape pixel electrode 415, and a common electrode 416 provided so as to overlap with the pixel electrode 415 when viewed from above, for each of the pixels P. A semiconductor layer of the thin-film transistor 430 is disposed along the Y direction so as to intersect with the scanning line 403 that extends in the X direction, and the portion of the scanning line 403 that intersects with the semiconductor layer functions as a gate electrode. The thin-film transistor 430 has a top-gate structure, in the same manner as the thin-film transistor 330 according to the third embodiment.

The semiconductor layer of the thin-film transistor 430 has an LDD structure, where the data line 406 is connected to a first source-drain region via a contact portion 431 and the pixel electrode 415 is connected to a second source-drain region via a contact portion 432.

The pixel electrode 415 and the common electrode 416 are disposed so as to face each other with an interlayer insulating film interposed therebetween. The common electrode 416 is also present between branch electrodes 415B of the pixel electrode 415. The common electrode 416 is connected to the common wire 404 to which the common potential (LCCOM) is supplied via a contact portion 405.

As shown in FIG. 13, a liquid crystal panel 410 of the liquid crystal device 400 includes the liquid crystal layer 350 interposed between the element substrate 10 that has the plurality of wire layers 11 to 14 provided upon the substrate 10s and the opposing substrate 20 disposed facing the element substrate 10 on another side of the sealant 40. The liquid crystal layer 350 contains liquid crystal molecules having positive dielectric anisotropy, for example, and the liquid crystal molecules are oriented approximately horizontally. An orientation layer that orients the liquid crystal molecules approximately horizontally is not shown in FIG. 13. The orientation layer is configured by, for example, rubbing a polyimide film in a predetermined direction.

The liquid crystal panel 410 includes the display region E1 in which the pixels P having the pixel electrode 415 and the common electrode 416 are arranged, the dummy pixel region E2 that surrounds the display region E1, and the parting region E3 that surrounds the dummy pixel region E2. The parting portion 21 is provided in the parting region E3, on the side of the opposing substrate 20 located toward the liquid crystal layer 350.

In the display region E1, the pixel electrode 415 is formed upon the third interlayer insulating film 14 using a transparent conductive film such as ITO. The common electrode 416 is formed in the wire layer 14 using the same transparent conductive film as the pixel electrode 415. The common wire 404 to which the common electrode 416 is connected is formed in the wire layer 13 that is below the wire layer 14. An approximately horizontal electrical field is produced by applying an AC voltage between the pixel electrode 415 and the common electrode 416, using the potential of the common electrode 416 as a reference, and light passing through the pixels P can be modulated based on image signals by changing the orientation direction of the approximately horizontally-oriented liquid crystal molecules to the direction of the electrical field. The display technique that employs an approximately horizontal electrical field produced between the pixel electrode 415 and the common electrode 416 formed in the different wire layers in this manner is referred to as the FFS (fringe field switching) technique.

In this embodiment, a first electrode 421 and a second electrode 422 are provided in the dummy pixel region E2. The first electrode 421 is formed using a transparent conductive film when the pixel electrode 415 is formed. The second electrode 422 is formed using the same transparent conductive film when the common electrode 416 is formed. Together, the first electrode 421 and the second electrode 422 configure a single dummy pixel.

A connection wire 423 is formed in the wire layer 14. A connection wire 424 is formed in the wire layer 13, in the same layer as the common wire 404 and using the same conductive film. The connection wire 423 is electrically connected to the first electrode 421, and the connection wire 424 is electrically connected to the second electrode 422.

### Driving Method of Liquid Crystal Device 400

The same common potential (LCCOM) as that supplied to the common wire 404 is supplied to the second electrode 422 via the connection wire 424. An AC potential that shifts between a higher potential and a lower potential relative to the potential of the second electrode 422 is supplied to the first electrode 421 via the connection wire 423. In other words, an AC voltage is applied between the first electrode 421 and the second electrode 422, using the potential of the second electrode 422 as a reference. This AC voltage is lower than the threshold voltage at which the transmissibility of the pixels P changes. As a result, the dummy pixels that each include the first electrode 421 and the second electrode 422 function as an electricity parting portion 420. Meanwhile, ionic impurities (cations and anions) present in the liquid crystal layer 350 are pulled toward the first electrode 421 by the approximately horizontal electrical field produced between the first electrode 421 and the second electrode 422. In other words, ionic impurities (cations and anions) can be swept from the display region E1 to the dummy pixel region E2.

Note that the frequency of the AC voltage applied between the first electrode 421 and the second electrode 422 is the same as the frequency of the AC voltage applied between the pixel electrode 415 and the common electrode 416, and is 60 Hz, for example.

Furthermore, the AC voltage applied between the first electrode 421 and the second electrode 422 may be set to the same voltage as the threshold voltage or a voltage that is higher than the threshold voltage after the display period has ended.

According to this embodiment, the electricity parting portion 420 that includes the first electrode 421 and the second electrode 422 produces an approximately horizontal electrical field in the same manner as the pixels P, but because the AC voltage applied between the first electrode 421 and the second electrode 422 is lower than the threshold voltage, the dummy pixel region E2 is kept in the normally-black display state. Accordingly, the electricity parting portion 420 that is not only capable of pulling ionic impurities but that also has superior view angle properties, in which leaking light is not apparent even when viewed from an angle, can be realized.

### Fifth Embodiment

### Electronic Device

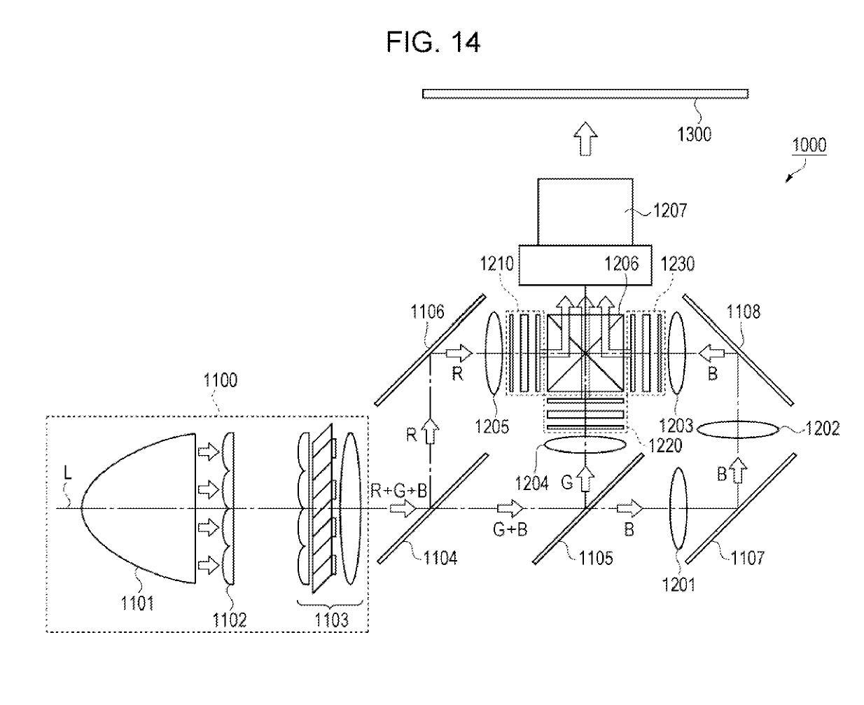

Next, a projection-type display apparatus serving as an electronic device according to a fifth embodiment will be described with reference to FIG. 14. FIG. 14 is a schematic diagram illustrating the configuration of the projection-type display apparatus.

As shown in FIG. 14, a projection-type display apparatus 1000 serving as an electronic device according to this embodiment includes a polarized illumination device 1100 disposed along a system optical axis L, two dichroic mirrors 1104 and 1105 serving as optical separating elements, three reflective mirrors 1106, 1107, and 1108, five relay lenses 1201, 1202, 1203, 1204, and 1205, three transmissive liquid crystal light valves 1210, 1220, and 1230 serving as optical modulating units, a cross dichroic prism 1206 serving as a light synthesizing element, and a projection lens 1207.

The polarized illumination device 1100 is generally configured of a lamp unit 1101 that serves as a light source and is configured of a white light source such as an ultra-high-pressure mercury lamp, a halogen lamp, or the like, an integrator lens 1102, and a polarization conversion element 1103.

Of a polarized light flux emitted from the polarized illumination device 1100, the dichroic mirror 1104 reflects red (R) light and transmits green (G) and blue (B) light. The other dichroic mirror 1105 reflects the green (G) light and transmits the blue (B) light that has passed through the dichroic mirror 1104.

The red (R) light reflected by the dichroic mirror 1104 enters the liquid crystal light valve 1210 via the relay lens 1205 after being reflected by the reflective mirror 1106.

The green (G) light reflected by the dichroic mirror 1105 enters the liquid crystal light valve 1220 via the relay lens 1204.

The blue (B) light transmitted by the dichroic mirror 1105 enters the liquid crystal light valve 1230 via an optical guide configured of the three relay lenses 1201, 1202, and 1203 and the two reflective mirrors 1107 and 1108.

The liquid crystal light valves 1210, 1220, and 1230 are disposed so as to face respective planes of incidence of each color of light in the cross dichroic prism 1206. The colored light that has entered the liquid crystal light valves 1210, 1220, and 1230 is modulated based on image information (image signals) and is emitted toward the cross dichroic prism 1206. This prism is formed by affixing four right-angle prisms, with a dielectric multilayer film that reflects red light and a dielectric multilayer film that reflects blue light being formed in a cross shape on inner surfaces thereof. The three colors of light are synthesized by these dielectric multilayer films, forming light that expresses a color image. The synthesized light is projected onto a screen 1300 by the projection lens 1207, which is a projecting optical system, and an image is displayed in an enlarged manner as a result.

The aforementioned liquid crystal device 100 or liquid crystal device 200 having the electricity parting portion 120 is applied in the liquid crystal light valve 1210. A pair of polarizing elements are disposed, with a gap therebetween, in a cross Nicol pattern on the entry and exit sides of the colored light in the liquid crystal panel 110 (or the liquid crystal panel 210). The same applies to the liquid crystal light valves 1220 and 1230.

According to this projection-type display apparatus 1000, the aforementioned liquid crystal device 100 or liquid crystal device 200 is used as the liquid crystal light valves 1210, 1220, and 1230, and thus a projection-type display apparatus 1000 that ameliorates display problems caused by ionic impurities and provides superior display quality can be provided.

The invention is not intended to be limited to the aforementioned embodiments, and many suitable changes can be made thereto without departing from the essence or spirit of the invention as set forth in the appended aspects of the invention and the specification as a whole; driving methods for liquid crystal devices and electronic devices that apply such liquid crystal devices derived from such modifications also fall within the technical scope of the invention. Many variations can also be considered in addition to the aforementioned embodiments. Several such variations will be described hereinafter.

### Variation 1

In the case where an AC voltage is applied between the dummy pixel electrodes 121 and 122 and the common electrode 23 in the liquid crystal device 100 and the driving method thereof, the dummy pixels DP may be given the same structure as the pixels P and a TFT 30 may be provided in each of the dummy pixel electrodes 121 and 122. Then, an AC potential may be applied to each of the dummy pixel electrodes 121 and 122 via the TFTs 30. By employing such a configuration, the AC voltage applied between the dummy pixel electrodes 121 and 122 and the common electrode 23 can be supplied using the data line driving circuit 101, rather than being supplied from the external connection terminals 104 (EA).

### Variation 2

The liquid crystal device 100, liquid crystal device 200, liquid crystal device 300, and liquid crystal device 400 are not limited to transmissive types. For example, the invention can also be applied in a reflective-type liquid crystal device in which the pixel electrodes 15, 315, and 415, the common electrodes 316 and 416, and so on are formed using a reflective conductive film, or in which a reflective layer is provided in a layer below the pixel electrodes 15, 315, and 415, and the common electrodes 316 and 416.

Furthermore, the invention is not limited to being applied in VA, IPS, and FFS liquid crystal devices, and can also be applied in an OCB (optically-compensated birefringence) liquid crystal device.

### Variation 3

The electronic device in which the liquid crystal device 100, liquid crystal device 200, liquid crystal device 300, and liquid crystal device 400 are applied is not limited to the projection-type display apparatus 1000 described in the aforementioned fifth embodiment. The liquid crystal devices can also be applied in projection-type HUDs (heads-up displays) and direct-view HMDs (head-mounted displays), as well as in the display units of information terminal devices such as electronic books, personal computers, digital still cameras, liquid crystal televisions, viewfinder-based or direct-view monitor-based video recorders, car navigation systems, electronic organizers, POSs, and so on.

The entire disclosure of Japanese Patent Application No. 2013-083766, filed Apr. 12, 2013 is expressly incorporated by reference herein.

What is claimed is:

1. A driving method for a liquid crystal device in which a liquid crystal layer is interposed between a first substrate and a second substrate affixed together using a sealant and that operates in a normally-black mode in which the transmissibility of pixels is minimum when no voltage is applied to the pixels, and that includes a first region in which an image is displayed and a second region positioned between the first region and the sealant and provided following an edge of the first region when viewed from above;
the method comprising:
forming pixel electrodes in the first region on the side of the first substrate that faces the liquid crystal layer and a common electrode in the first region on the side of the first substrate or the second substrate that faces the liquid crystal layer;
forming a first electrode in the second region on the side of the first substrate that faces the liquid crystal layer and a second electrode in the second region on the side of the first substrate or the second substrate that faces the liquid crystal layer; and
applying a voltage that is lower than a threshold voltage at which the transmissibility of the liquid crystal layer changes between the first electrode and the second electrode.

2. The driving method for a liquid crystal device according to claim 1, comprising:
applying an AC potential that shifts between a higher potential and a lower potential than a potential of the second electrode to the first electrode.

3. The driving method for a liquid crystal device according to claim 2, comprising:
supplying the frequency of the AC potential being the same as the frequency of an image signal supplied to the pixel electrodes in the first region.

4. The driving method for a liquid crystal device according to claim 1, comprising:
applying a DC potential that is lower than a potential of the second electrode to the first electrode.

5. The driving method for a liquid crystal device according to claim 4, which further includes a third electrode provided between the second region and the sealant;
the method comprising:
applying a DC potential that is higher than a potential of the first electrode and lower than a potential of the second electrode to the third electrode.

6. The driving method for a liquid crystal device according to claim 1, comprising:
setting the voltage applied between the first electrode and the second electrode to be the same voltage as the threshold voltage or a higher voltage than the threshold voltage after a display period has ended.

7. A liquid crystal device in which a liquid crystal layer is interposed between a first substrate and a second substrate affixed together using a sealant and that operates in a normally-black mode in which the transmissibility of pixels is minimum when no voltage is applied to the pixels, the device comprising:
a first region in which an image is displayed;
a second region positioned between the first region and the sealant and provided following the first region when viewed from above,
wherein pixel electrodes are formed in the first region on the side of the first substrate that faces the liquid crystal layer and a common electrode is formed in the first region on the side of the first substrate or the second substrate that faces the liquid crystal layer;
a first electrode formed in the second region on the side of the first substrate that faces the liquid crystal layer and a second electrode is formed in the second region on the side of the first substrate or the second substrate that faces the liquid crystal layer; and
a voltage that is lower than a threshold voltage at which the transmissibility of the liquid crystal layer changes is applied between the first electrode and the second electrode during a display period.

8. The liquid crystal device according to claim 7,
wherein the common electrode is formed in the second substrate across the first region and the second region and also functions as the second electrode.

9. The liquid crystal device according to claim 7,
wherein the second electrode is formed in the first substrate.

10. The liquid crystal device according to claim 7,
wherein a third electrode is provided between the second region and the sealant, and a negative-polarity potential higher than a potential of the first electrode is applied to the third electrode.

11. The liquid crystal device according to claim 7, further comprising:
an inorganic orientation layer that covers the pixel electrode, the first electrode, the second electrode, and the common electrode.

12. An electronic device comprising:
a liquid crystal device in which a liquid crystal layer is interposed between a first substrate and a second substrate affixed together using a sealant and that operates in a normally-black mode in which the transmissibility of pixels is minimum when no voltage is applied to the pixels,
wherein the liquid crystal device is driven using the driving method for a liquid crystal device according to claim 1.

13. An electronic device comprising the liquid crystal device according to claim 7.
